(19) United States
(12) Patent Application Publication
(10) Pub. No.: US 2008/0202014 A1
(43) Pub. Date: Aug. 28, 2008

(54) KITE FISHING LURE THAT GENERATES A SPLASHING EFFECT ON A BODY OF WATER

(76) Inventor: ALEX PALERMO, DAVIE, FL (US)

Correspondence Address: PATENTS ON DEMAND, P.A., 4581 WESTON ROAD, SUITE 345, WESTON, FL, 33331, US

(21) Appl. No.: 11/678,951

(22) Filed: Feb. 26, 2007

(51) Int. Cl. A01K 85/00; A01K 85/01

(52) U.S. Cl. 43/26.2; 43/42.06; 43/42.09

(57) ABSTRACT

A fishing lure that generates a splashing effect when deployed in a body of water and attached to a kite fishing assembly. This splashing effect attracts target fish in the same manner that live bait does. Different optional features can be included in the kite fishing lure. One option is to include a chemical concavity configured to store a chemical substance that is dispersed into the body of water in concentrations designed to attract proximate located fish. Another option is to include a movement simulator designed to simulate movement of a struggling bait fish. Yet another option is to include a replaceable skin sheaf designed to be periodically replaced after being worn from repetitive usage.

### BACKGROUND

1. Field of the Invention

The present invention relates to the field of kite fishing and, more particularly, to a kite fishing lure that generates a splashing effect on a body of water.

2. Description of the Related Art

Kite fishing is a popular technique specialized for catching large, predatory fish, such as sailfish, kingfish, dolphin, marlin and wahoo, in the open ocean. This technique keeps the bait away from the noise of the fishing vessel 104 and close to the water's surface, where a bait splashes the surface of the water, which attracts target fish. In the basic apparatus, shown in FIG. 1, fishing lines 115 are attached to a kite line 110 via a kite clip assembly 120. The kite 105, also attached to the kite line 110, provides the lift necessary to keep the live bait 125 attached to the fishing lines 115 close to the water's surface. As the live bait 125 swims frantically, trying to dive or escape, it struggles on the surface of the water, attracting predatory fish with splashing movements and resultant vibrations and splashing effects. When a live bait 125 is taken, the force releases the fishing line 115 from the kite clip assembly 120 and the kite line 110. A fisherman can then use the rod and reel 112 to wind in the fishing line 115. The seized line can then be attended to while any other lines 115 await a bite.

Use of the kite 105 permits fishing from a side of a vessel 104 opposite of the wind direction 102. A freeline or flatline can additionally be deployed on the side of the vessel 104 corresponding to the wind direction 102. The wind can carry the freeline away from the vessel (i.e., floating away). That is, live bait 125 can be attached to the freeline and a buoy or a helium balloon (i.e., used to keep the fish near/at the surface). This bait 125 can splash the surface of the water, which attracts target fish. Accordingly, freeline fishing is used in addition to and/or in place of kite fishing, using the same type of bait 125, fishing for the same type of predatory fish, and attracting the predatory fish based upon splashing effects on the surface of a body of water.

The use of live bait is often a prohibitive or at least a costly factor to the sport of kite fishing. The price of a single piece of live bait can range from $2 to $5 ($24 to $60 a dozen), depending on the type of bait. A kite fisherman can easily spend hundreds of dollars on bait alone for a single day of fishing. This is especially true of kite fishing tournaments where running out of bait while out on the ocean is detrimental to a fisherman's performance. Further, kite fishing tournaments are often three day events, where large quantities of expensive live bait are required for each day.

Use of live bait 125 has other disadvantages. For example, live baits that have a hook penetrating their body tend to exhaust themselves and to eventually die. Live baits 125, such as goggle eyes, will typically die after approximately twenty to thirty minutes after being hooked. When the live bait 125 tires or dies, it no longer splashes the surface of the water, and therefore no longer attracts prey fish. A tired or dead bait 125 forces a fisherman to retrieve the kite 105 and lines 115 so that replacement bait fish 125 can be attached and re-deployed into the water.

Currently, kite fishermen do not have the option to use artificial lures. Existing artificial lures are designed for more traditional fishing techniques, not kite fishing or freeline fishing. For example, an existing artificial lure may mimic the shape of a bait fish, but it does not create the splashing effect that is critical for kite fishing bait to attract predatory fish. What is needed is an artificial lure to use in kite fishing that can recreate the splashing effect of struggling live bait.

### SUMMARY OF THE INVENTION

A fishing lure that generates a splashing effect when deployed in a body of water and attached to a kite fishing assembly. This splashing effect attracts target fish in the same manner that live bait does. Different optional features can be included in the kite fishing lure. One option is to include a chemical concavity configured to store a chemical substance (e.g., fish oil, chum, etc.) that is dispersed into the body of water in concentrations designed to attract proximate located fish. Another option is to include a movement simulator designed to simulate movement of a struggling bait fish. Yet another option is to include a replaceable skin sheaf designed to be periodically replaced after being worn from repetitive usage.

The present invention can be implemented in accordance with numerous aspects consistent with the material presented herein. For example, one aspect of the present invention can include a fishing lure including a splashing effect actuator and at least one fishing hook. The splashing effect actuator can automatically generate disturbances on a surface of a body of water when the fishing lure is deployed within the body of water and when the fishing lure is connected to a kite, which is part of a kite fishing assembly.

Another aspect of the present invention can include a fishing lure that includes an action chamber and multiple different lure bodies. The action chamber can include a splashing effect actuator. Each lure body can be designed so that a human agent is able to detachably couple the action chamber to the lure body. When the fishing lure is deployed the action chamber can be coupled to one of the lure bodies. The lure bodies can resemble different bait fish and can have different optional components, such as a chemical concavity and a motion simulation actuator. Further, electrical components of the action chamber can be in a waterproof concavity, which protects these components when the lure is deployed.

Still another embodiment of the present invention can include a method for kite fishing that uses an artificial lure. In the method, a fishing lure can be attached to a fishing line and can also be hooked to a kite fishing clip attached to a kit fishing assembly. The fishing lure can then be deployed into a body of water. When deployed, the fishing lure can utilize an electrical energy component internal to the fishing lure to generate mechanical energy that powers a splashing effect actuator. The splashing effect actuator can automatically generate non random disturbances on a surface of the body of water. The generated disturbances can emulate splashing motions produced by live bait fish when the live bait fish are attached to a similar kite fishing assembly and are deployed in a body of water.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a prior art kite fishing system.

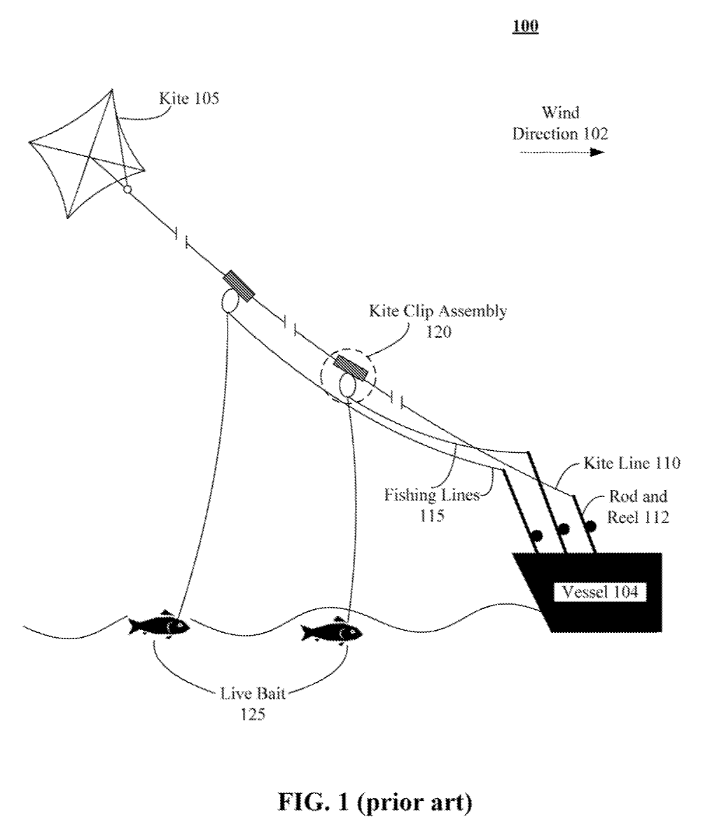

FIG. 2 is a schematic diagram illustrating a system for using artificial lures for kite fishing in accordance with embodiments of the inventive arrangements disclosed herein.

FIG. 3 depicts an artificial lure to be used when kite fishing in accordance with an embodiment of the inventive arrangements disclosed herein.

FIG. 4 is a collection of illustrations depicting possible kite fishing lure configurations in accordance with an embodiment of the inventive arrangements disclosed herein.

FIG. 5 is a collection of illustrations depicting possible kite fishing lure configurations in accordance with an embodiment of the inventive arrangements disclosed herein.

FIG. 6 is a collection of illustrations depicting sample embodiments of the splashing effect actuator in accordance with the inventive arrangements disclosed herein.

FIG. 7 is a flow chart of a method for utilizing an artificial lure when kite fishing in accordance with an embodiment of the inventive arrangements disclosed herein.

### DETAILED DESCRIPTION OF THE INVENTION

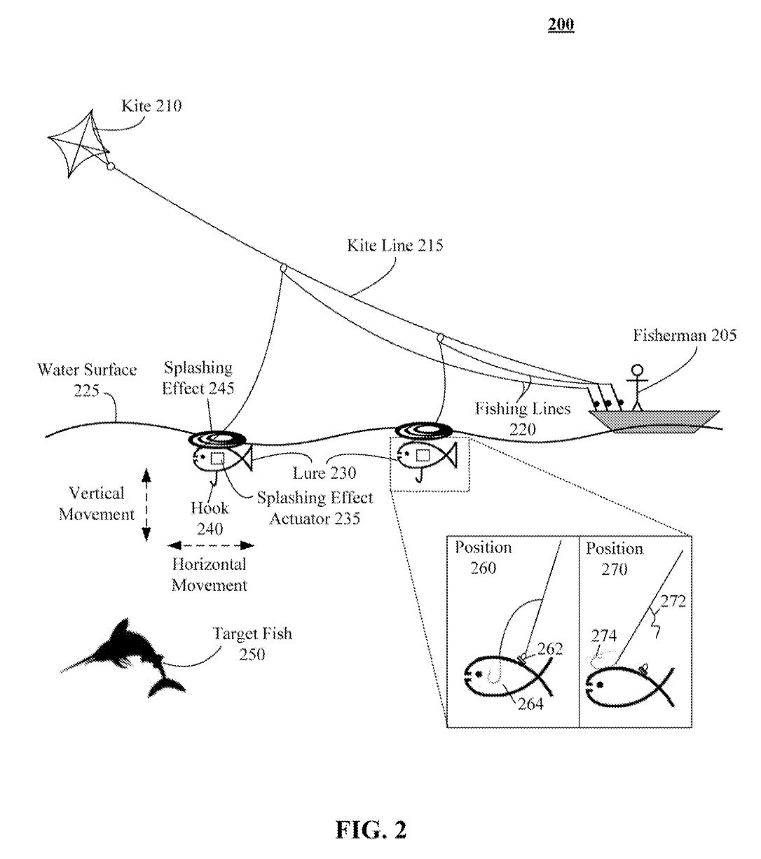

FIG. 2 is a schematic diagram illustrating a system 200 for using artificial lures for kite fishing in accordance with embodiments of the inventive arrangements disclosed herein. In this system 200, a fisherman 205 an attach lures 230 to one or more fishing lines 220. The fishing lines 220 can then be attached to the kite line 215. When the kite 210 is flown, the fishing lines 220 can be positioned at designated distances, deploying the attached lures 230.

Once deployed, the splashing effect actuator 235 can cause the lures 230 to generate the splashing effect 245 on the surface 225 of the water. The splashing effect 245 can emulate splashing/ripples generated by a live bait fish, when the live bait fish is attached to the kite line 215. The kite 210 and lines, which are repetitively being adjusted by the fisherman 205, can ensure that the lure 230 floats near the water surface 225. In one embodiment, the splashing effects 245 can be selectively created only when the lure 230 approaches the water surface 225.

When a target fish 250 attempts to eat the lure 230, the target fish 250 can become caught on one or more attached hooks 240. At this point, the specific fishing line 220 can detach from the kite line 215 and the fisherman 205 can attempt to capture the target fish 250.

In one arrangement, the hook can be designed to swivel into the target fish 250, whenever the lure 230 is taken to ensure that the target fish 250 is punctured by the hook 250. Position 260 shows the lure and hook arrangement before the lure is struck. In position 260, a main line is attached to a clip assembly 262 and the hook 264 that is recessed into the lure is attached to an auxiliary line, as shown. When the target fish 250 seizes the lure, as shown by position 270, the main line detaches 272 from the clip assembly 262, which pulls the auxiliary line taunt, thus rotating the hook 274. The rotated hook is positioned to penetrate the target fish 250, thereby ensuring its capture.

It should be appreciated that position 260 and 270 are provided to illustrate the concept that the lure 230 hook can move, when the lure 230 is seized. The invention should not be construed as limited to the exact combination shown, and other hook movement mechanisms are contemplated.

It should also be appreciated that although system 200 illustrates the lure 230 being attached to the kite 210 assembly, the lure 230 can also be used when freeline fishing, to the same effect. In freeline fishing, however, the lure 230 can be designed to be relatively buoyant, since no kite 210 ensures that the lure 230 remains proximate to the water surface 225. In one configuration, the lure 230 itself need not be buoyant, but an additional buoy or other lifting mechanism can be attached to the freeline to keep the lure 230 near the water surface 225. Thus, the same lure 225 that is used for kite fishing can be used for freeline fishing.

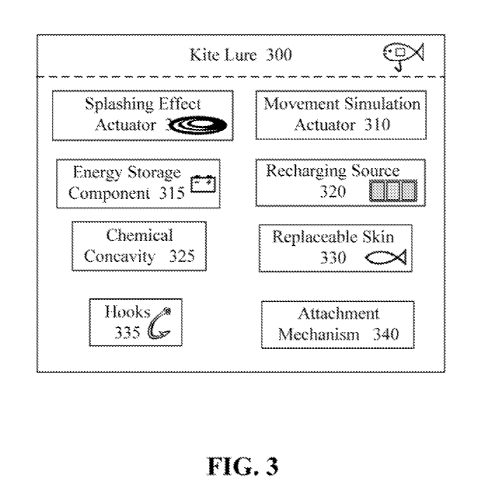

FIG. 3 depicts an artificial lure 300 to be used when kite fishing in accordance with an embodiment of the inventive arrangements disclosed herein. The kite lure 300 can be used in the context of system 200 or any fishing system supporting the use of artificial lures that produce splashing effects. For example, the kite lure 330 can be used for freeline fishing.

The kite lure 300 can include a variety of components such as a splashing effect actuator 305, a movement simulation actuator 310, an energy storage component 315, a recharging source 320, a chemical concavity 325, a replaceable skin 330, one or more hooks 335, and an attachment mechanism 340. The attachment mechanism 340 can be the means by which the lure 300 is fastened to a fishing line. Further, the attachment mechanism 340 can permit the kite lure 300 to be attached to a kite fishing assembly (e.g., a kite clip assembly).

The splashing effect actuator 305 can be a component that causes perturbations or non random disturbances to appear upon a surface of a body of water, referred to herein as splashing effects. These splashing effects are designed to simulate disturbances produced on a surface of a body of water by live bait fish or by fish that target kite fishing fish, such as sailfish, kingfish, marlin, and wahoo, typically prey upon. In one embodiment, the lure 300 can intermittently move (i.e., along a vertical plan) to the surface of a body of water and create ripples or the splashing effect. In another embodiment, the splashing effect can be caused by a mechanical component, which does not require the lure 300 to break a water's surface. For example, the splashing effect actuator 305 can intermittently emit a jet of water/air that results in splashing effects being formed. The splashing effect actuator 305 can be implemented in a variety of manners, including, but not limited to, a snapping mechanism, a paddlewheel mechanism, a rotational flapping mechanism, a vertical motion mechanism, and the like.

The motion simulation actuator 310 can be a component that causes the lure 300 to be propelled and/or change direction in a horizontal plane. The movement simulation actuator 310 can include existing mechanisms that are commercially available and used with other fishing techniques. Other motions can also be simulated by the motion simulator actuator 310 designed to simulate movements characteristic of a live bait fish in distress. For example, a chaotic pendulum can be used to generate vigorous and non-predictable motions of a distressed bait fish. Generated splashing effects can result in part from motions of the actuator 310, or can be independent of these motions (e.g., generated by a separate actuating component 305).

The energy storage component 315 can be a means for storing energy for use by the lure 300 and/or its components. The energy storage component 315 can be implemented in a variety of ways, including, but not limited to, an electric battery, a mechanical spring, a capacitor, a photolytic cell, a hydroelectric cell, and the like. For example, the energy storage component 315 can be a battery that powers the splashing effect actuator 305. It should be noted that the type and amount of energy stored is dependent on the overall power requirements of the lure 300 and its components.

In cases where a rechargeable energy source is used as a power source, the lure 300 can include a recharging source 320. The recharging source 320 can increase the power content of the energy storage component 315. For example, the recharging source 320 could be implemented as solar panels to recharge a photolytic energy store. The recharging can occur either when the lure 300 is deployed in the water or when the lure is in a non-deployed state. For example, a solar panel can be used to charge the lure 300 when the lure 300 is not in use. In another example, a paddlewheel (functioning as component 320) internal to the lure 300 can be drug behind a moving vessel (such as when trolling) and used to recharge the energy storage component 315.

The chemical concavity 325 can allow the dispersal of fish attractant (e.g. fish oil, chum, and the like) into the water in order to attract more target fish to the area where the lure 300 is located. The chemical concavity 325 can be a hollow within or attached to the lure 300 where the fish attractant can be placed. The chemical concavity 325 can include a means to allow water to pass through the concavity 325, such as flow holes or pores, when the lure 300 is deployed.

The use of a replaceable skin 330 to encapsulate the lure 300 can extend the useable life of the lure 300. For example, a target fish can gouge or otherwise damage the body of the lure 300 when taking the bait. Such damage can render the lure 300 unusable or impair its functionality. Similar damage to a replaceable skin 330 can leave the underlying lure 300 with minimal damage, extending the lure's 300 usability.

Further, the replaceable skin 330 can increase the versatility of the lure 300 by providing a means to change the lure's 300 appearance. For example, a fisherman could use a tuna skin in the first cast and a squid skin on a subsequent cast. It should be appreciated that this also allows the fisherman to alter the lure 300 dynamically in response to the current fishing conditions. For example, if the marlin are not going for a pilchard skin on the lure 300, then the fisherman can bring in the line and change to a goggle-eye skin. This process can continue until the fisherman is satisfied with the reaction to the skin 330 on the lure 300.

Different replaceable skins 330 can be designed in different colors, depending upon a type of fish that is being specifically sought. For example, dolphins are generally attracted to bright colors, like yellow and green. When fishing for dolphins, a yellow and/or green skin 330 can be used. In another example, wahoos are generally attracted to blue and white colors. A fishing seeking wahoos in particular can select a blue and/or white skin 330 for the kite lure 300.

The kite lure 300 can also include one or more hooks 335 in order to pierce an attaching target fish. The hooks 335 can be attached to the lure 300 body and/or the replaceable skin 330. In one contemplated embodiment, the hooks 335 can be affixed to the lure 300 body and the replaceable skin can include openings that allow the hooks 335 to protrude through the skin 330. Additionally, the hooks 335 can be attached to one or more lines in a manner that causes the hook 335 to swivel when struck, as illustrated by position 260 and 270 of system 200.

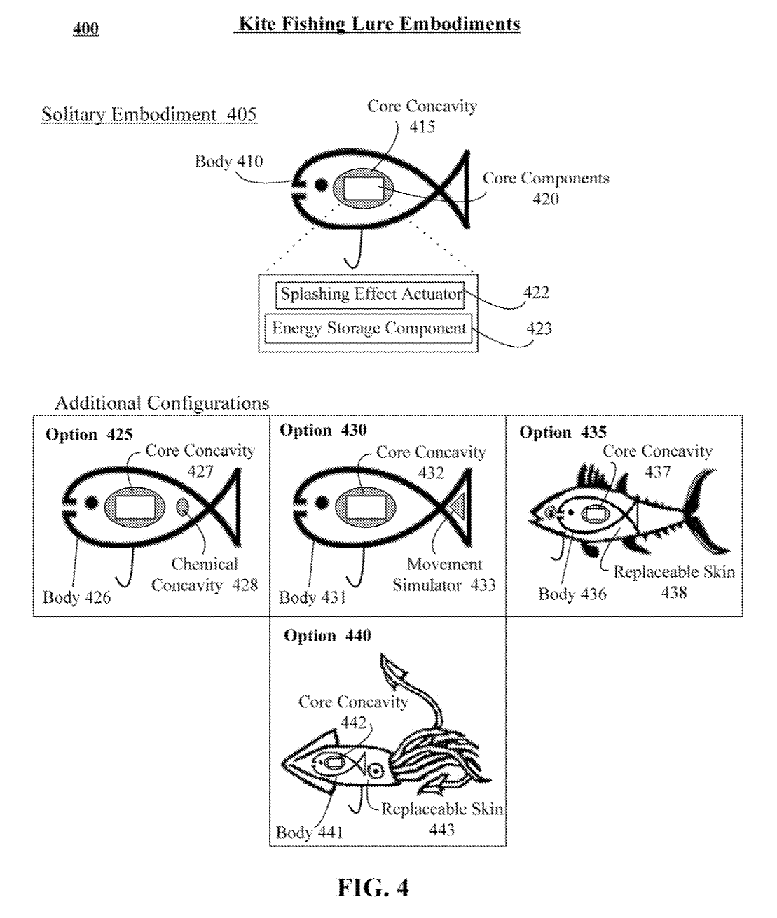

FIG. 4 is a collection of illustrations 400 depicting possible kite fishing lure configurations in accordance with an embodiment of the inventive arrangements disclosed herein. The collection of illustrations 400 can represent example configurations of the kite fishing lure 300 of FIG. 3. It should be appreciated that the collection 400 is not meant to represent an exhaustive list of all possible component combinations; it is meant for illustrative purposes.

This collection 400 includes configurations that can be classified as solitary embodiments 405 because the lure is a single and complete object. The solitary embodiment 405 of the lure can include a body 410 shaped to represent a physical model of the corresponding living bait fish. That is, the lure body 410 should match the physical characteristics of the bait fish it is meant to represent. For example, a tuna lure would be a reasonable facsimile to the tuna typically used a bait by kite fisherman.

The lure body 410 can include a core concavity 415 that can house the core components 420. For basic functionality, the core components 420 can include a splashing effect actuator 422 and an energy storage component 423. In one embodiment, the core concavity 415 can be a waterproof concavity. In another component, the core components 420 can be encased in a waterproof substance, such as encased in a plastic block or a water-proof gel, and the waterproof substance can be placed in the core concavity 415.

Additional configurations of the solitary embodiment 405 can be created by including supplementary components, such as those illustrated in options 425 through 440. Option 425 illustrates a lure configuration that can include a chemical concavity 428 within the body 426 in addition to the core concavity 427. The chemical concavity 428 can exist anywhere within the lure body 426 with provisions to allow water to be exposed to the contained fish attractant. The fish attractant can be a solid dissolvable in water or a liquid that is dispersed in the water over time.

Option 430 illustrates a lure configuration that includes a movement simulator 433 within the body 431 in addition to the core concavity 432. This option 430 can provide the lure with movement that is performed in addition to and independently of the splashing effect actuator 422.

Option 435 illustrates a lure configuration in which the lure body 436 can be encapsulated within a replaceable skin 438 representing a tuna. The lure body 436 can contain the core concavity 437 in order to provide the necessary rippling effect.

Option 440 also illustrates a lure configuration in which the lure body 441 containing the core concavity 442 can be encapsulated within a replaceable skin 443 representing a squid. This option 440 can illustrate that the overall shape of the replaceable skin 443 need not be an exact replica of the lure body 441.

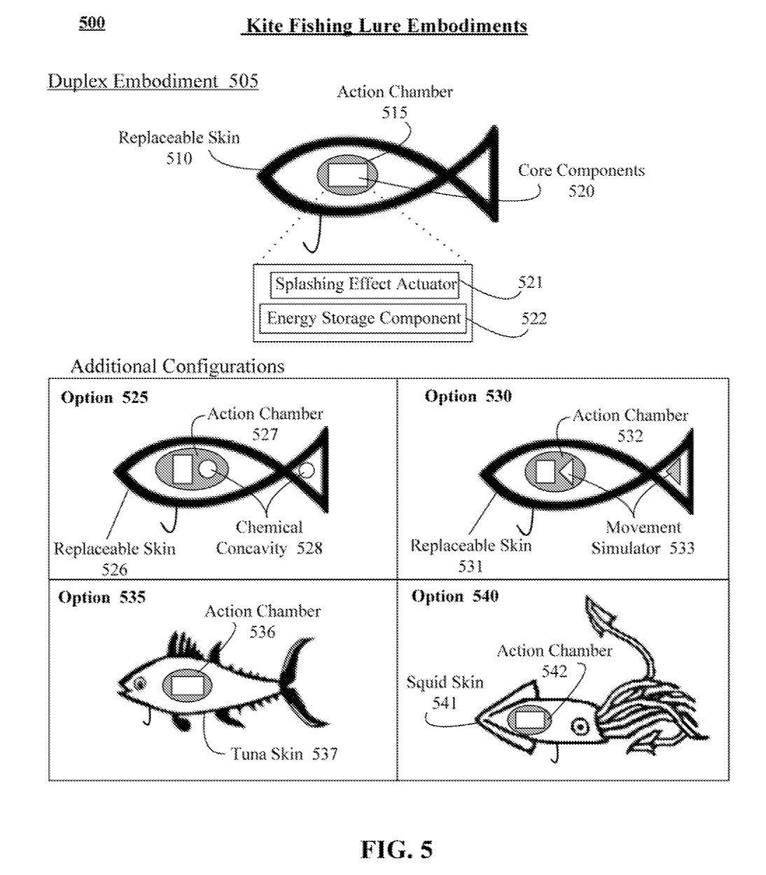

FIG. 5 is a collection of illustrations 500 depicting possible kite fishing lure configurations in accordance with an embodiment of the inventive arrangements disclosed herein. The collection of illustrations 500 can represent example configurations of the kite fishing lure 300 of FIG. 3. It should be appreciated that the collection 500 is not meant to represent an exhaustive list of all possible component combinations; it is meant to illustrative purposes.

This collection 500 includes configurations that can be classified as duplex embodiments 505 because the lure requires two individual pieces in order to create a complete lure. The duplex embodiment 505 of the lure can include a replaceable skin 510 shaped to represent a physical model of the corresponding living bait fish and an action chamber 515. It should be noted that in this embodiment, both the replaceable skin 510 and action chamber 515 are required to create a functional lure.

The action chamber 515 can house the core components 520. For basic functionality, the core components 520 can include a splashing effect actuator 521 and an energy storage component 522.

Additional configurations of the duplex embodiment 505 can be created by including supplementary components, such as those illustrated in options 525 through 540. Option 525 illustrates a lure configuration that can include a replaceable skin 526, an action chamber 527, and a chemical concavity 528. The chemical concavity 528 can exist either within the action chamber 527 and/or the replaceable skin 526.

Option 530 illustrates a lure configuration that can include a replaceable skin 531, an action chamber 532, and a movement simulator 533. The movement simulator 533 can exist either within the action chamber 532 and/or the replaceable skin 531. This option 530 can provide the lure with movement that is performed in addition to and independently of the splashing effect actuator 522.

Option 535 and option 540 illustrate the use of bait-specific skins with the duplex embodiment 505. In option 535, the action chamber 536 can be encapsulated within a tuna skin 537, creating a tuna lure. In option 540, the action chamber 542 can be encapsulated within a squid skin 541, creating a squid lure.

It should be appreciated that the duplex embodiment 505 affords great versatility in the fact that a single action chamber 515 can be used with a variety of different replaceable skins 510.

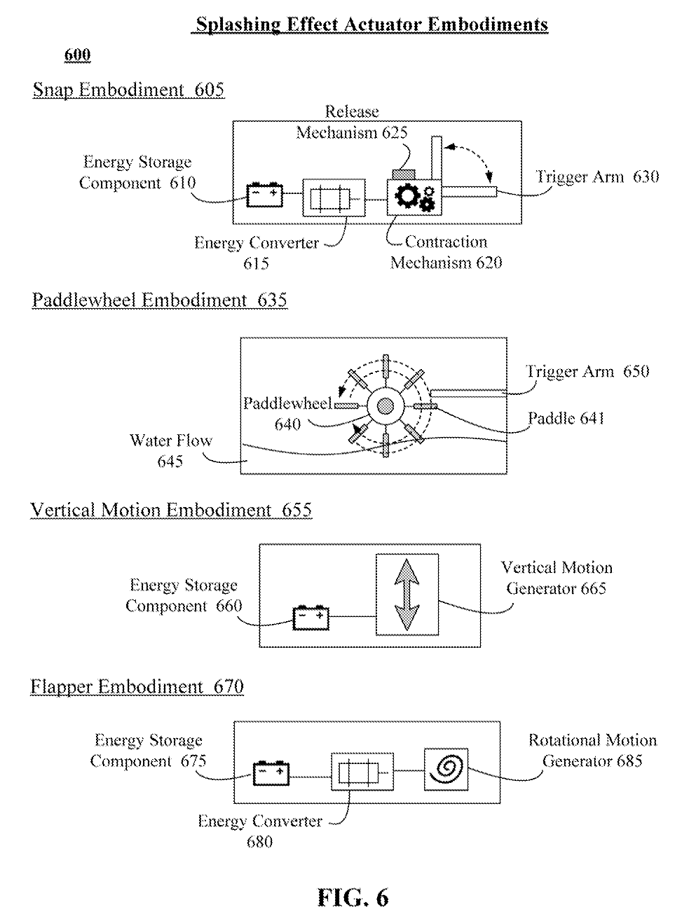

FIG. 6 is a collection of illustrations 600 depicting sample embodiments of the splashing effect actuator in accordance with the inventive arrangements disclosed herein. The collection of illustrations 600 can represent example embodiments of the splashing effect actuator 305 of kite fishing lure 300 of FIG. 3. It should be appreciated that the collection 600 is not meant to represent an exhaustive list of all possible embodiments; it is meant for illustrative purposes.

The splashing effect actuator can be utilized within an artificial kite fishing lure to create the splashing effects necessary to attract the attention of proximate target fish. Implementations of the splashing effect actuator can include, but are not limited to, a snap embodiment 605, a paddlewheel embodiment 635, a vertical motion embodiment 655, a flapper embodiment 670, and the like.

The snap embodiment 605 can represent a mechanism that contracts and releases a portion of the lure with a snapping motion to create splashing effects. This embodiment 605 can include an energy storage component 610 that supplies power to an energy converter 615. The energy converter 615 can then convert the type of energy received from the energy storage component 610 to the type of energy required for the contraction mechanism 620. For example, a battery can supply electrical energy to a motor that converts the electricity into mechanical energy.

The contraction mechanism 620 can provide the means by which a portion of the lure is brought to a contract position. As the energy converter 615 powers the contraction mechanism 620, the contraction mechanism 620 can contract a trigger arm 630. The trigger arm 630 can be connected to an area of the lure, thereby contracting the connected area of the lure as the trigger arm 630 contracts.

When the trigger arm 630 is contracted to the desired position, a release mechanism 625 can be triggered to cause the sudden release of the tension contracting the trigger arm 630. The release mechanism 625 can be triggered by the trigger arm 630 or by a mechanism internal to the contraction mechanism 620. For example, the release mechanism 625 can be a button depressed by the trigger arm 630 when the trigger arm 630 reaches a specific position. Alternatively, the release mechanism 625 can be a lever that is hit by a protrusion attached to a gear within the contraction mechanism 620.

The paddlewheel embodiment 635 can use the natural water flow 645 of the deployed lure to create a splashing effect. As the water flow 645 passes through the lure, the paddlewheel 640 can rotate in the direction of the flow. It should be noted that the paddlewheel 640 can function regardless of the water flow 645 direction, both clockwise and counterclockwise, and such changes in direction do not adversely affect its function.

As the paddlewheel 640 rotates, its paddles 641 can strike a trigger arm 650. The trigger arm 650 can be flexible, bending to allow the paddle 641 to pass it. The trigger arm 650 can be implemented in a variety of manners to create a splashing effect. For example, the trigger arm 650 can be connected to a section of the lure body, such as an attached fin or flipper, and propagate the paddling motion of the paddles 641 to this section. Alternately, the flexing of the trigger arm 650 can result in the trigger arm 650 slapping the water flow 645, creating a splashing effect in the water flow 645 that can be carried into the larger body of water.

In another contemplated embodiment, the paddlewheel 640 can be externally affixed to the lure to provide a similar effect. It should be noted that an external paddlewheel 640 can be used in conjunction with additional embodiments of a splashing effect actuator to provide a variety of rippling actions.

The vertical motion embodiment 655 can cause a deployed lure to move vertically to break the water's surface. A lure breaking the water's surface can simulate the feeding habits of the bait fish as well as create splashing effects.

The vertical motion generator 665 can be powered by an energy storage component 660. The vertical motion generator 665 can be implemented in a variety of ways, including, but not limited to, a chemical reaction chamber, an air bladder, a motor, a propeller, a lead line ascension mechanism, and the like.

In the flapper embodiment 670, the kite lure can be rotated along its lateral axis, essentially producing a motion similar to half of a barrel roll. This action can be produced by a rotational motion generator 685 connected to the lure. An energy converter 680 can be connected to the rotational motion generator 685 to provide the proper energy type from the energy storage component 675.

It should be noted that additional protrusions, such as those that simulate bait fish fins, can be added to the lure to increase the amount and intensity of the splashing effect produced in the flapper embodiment 670.

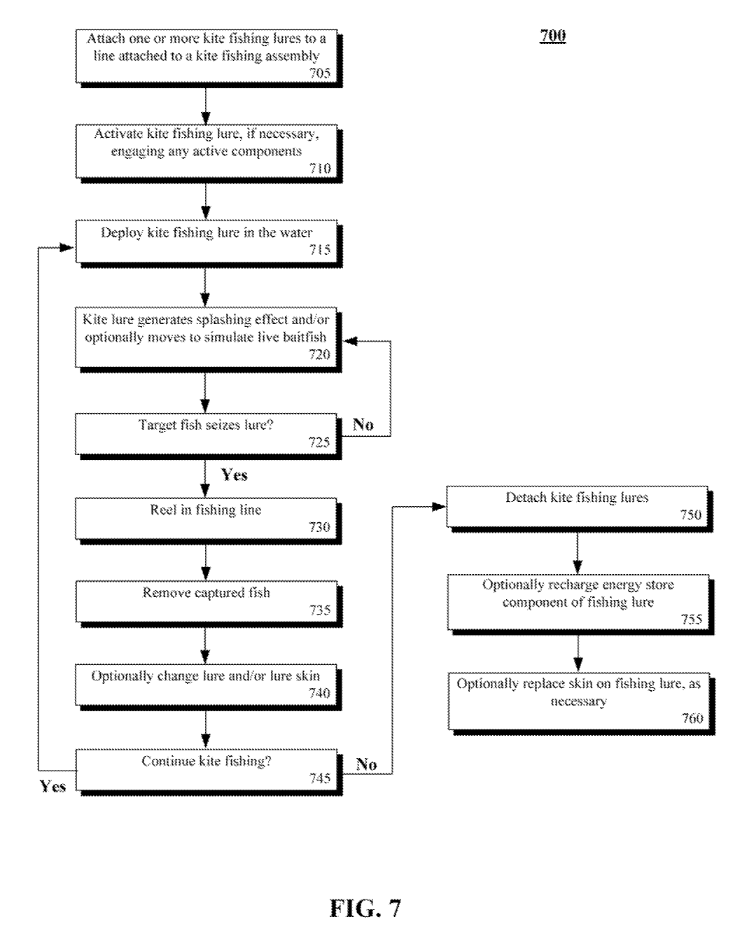

FIG. 7 is a flow chart of a method 700 for utilizing an artificial lure when kite fishing in accordance with an embodiment of the inventive arrangements disclosed herein. Method 700 can be performed in the context of system 200 and utilize the kite lure 300 and/or any of the splashing effect actuator embodiments of FIG. 6.

Method 700 can begin with step 75 where one or more artificial kite fishing lures can be attached to a kite fishing assembly. In step 710, the kite fishing lure can be activated, if necessary, in order to engage any active components. For example, a vertical motor can be switched from an inactive to an active state.

The kite fishing lure can then be deployed in the water in step 715. In step 720, the kite lure can generate splashing effects and/or move to simulate live bait fish, when such an option is available for the lure. A kite fisherman can determine if a target fish has seized a lure in step 725. When it is determined that a target fish has not seized the lure, the method can continue to repeat step 720.

When it is determined that a target fish has seized the lure, step 730 can execute, in which the fisherman can reel in the corresponding fishing line. In one embodiment, a hook attached to the lure can swivel when the lure is seized, which helps ensure the target fish is captured. One reeled in, the fisherman can remove the captured fish in step 736. Step 740 can provide the fisherman with the option to change the lure and/or the replaceable skin.

In step 745, the fisherman can determine if the kite fishing excursion is complete. When kite fishing is to continue, the method can return to step 715. Upon the completion of kite fishing, step 750 can execute where the fisherman can detach the kite fishing lures from the fishing lines.

In step 755, the fisherman can optionally recharge the energy store component of the lure. The replaceable skin of the lure can be optionally replaced in step 760.

This invention may be embodied in other forms without departing from the spirit or essential attributes thereof. Accordingly, reference should be made to the following claims, rather than to the foregoing specification, as indicating the scope of the invention.

What is claimed is:

1. A fishing lure comprising:
a splashing effect actuator configured to automatically generate a splashing effect on a surface of a body of water when the fishing lure is deployed within the body of water and when the fishing lure is connected to at least one of a kite fishing assembly and a freeline; and
at least one fishing hook.

2. The fishing lure of claim 1, further comprising:
a lure body comprising a chemical concavity, said concavity configured to store a chemical substance that is dispersed into the body of water in concentrations designed to attract proximate located fish.

3. The fishing lure of claim 1, further comprising:
an energy storage component contained within a body of fishing lure, said energy storage component producing electrical energy that powers the splashing effect actuator.

4. The fishing lure of claim 3, wherein the energy storage component comprises at least one of a battery and a capacitor.

5. The fishing lure of claim 3, wherein the energy storage component is configured to be recharged by at least one of a hydroelectric recharging source and a photolytic recharging source.

6. The fishing lure of claim 5, wherein the energy storage source is automatically recharged when deployed within the body of water and connected to the kite.

7. The fishing lure of claim 1, further comprising:
an energy storage component contained within a body of the fishing lure, said energy storage component producing mechanical energy that powers the splashing effect actuator.

8. The fishing lure of claim 1, further comprising:
a replaceable skin covering body of the fishing lure.

9. The fishing lure of claim 1, wherein the fishing lure is shaped to emulate at least one of a goggle-eye, a blue runner, a pilchard, a herring, a Spanish sardine, a speedo, a cigar minnow, a ballyhoo, a bonito, a grunt, a mullet, a jack, a tuna, a skip jack, and a squid.

10. The fishing lure of claim 1, further comprising:
a motion simulation actuator configured to mechanically generate movement in a direction along a horizontal plane to simulate movement of live bait fish.

11. The fishing lure of claim 10, wherein the motion simulation actuator is specifically configured to simulate motion of a particular type of bait fish, said type of bait fish being selected from a group consisting of a goggle-eye, a blue runner, a pilchard, a herring, a Spanish sardine, a speedo, a cigar minnow, a ballyhoo, a bonito, a grunt, a mullet, a jack, a tuna.

12. A fishing lure comprising:
an action chamber comprising a splashing effect actuator configured to automatically generate a splashing effect on a surface of a body of water when the fishing lure is deployed within the body of water and when the fishing lure is connected to at least one of a kite fishing assembly and a freeline;
a plurality of lure bodies, each lure body being designed so that a human agent is able to detachably couple the action chamber to the lure body, wherein when the fishing lure is deployed the action chamber is coupled to one of the lure bodies; and
at least one fishing hook attached to the fishing lure.

13. The fishing lure of claim 12, wherein the action chamber further comprises:
an energy storage component contained within a body of the fishing lure, said energy storage component producing electrical energy that powers the splashing effect actuator, wherein when said action chamber is coupled to the lure body, the energy storage component and other electronic components of the action chamber are contained within a waterproof section of the fishing lure.

14. The fishing lure of claim 12, wherein different ones of the lure bodies are shaped to emulate different kite fishing bait fish.

15. The fishing lure of claim 12, wherein the different lure bodies include different arrangements of a set of lure options, said lure options comprising a chemical concavity, a replaceable skin sheaf, a motion simulation actuator, a hook arrangement, an energy storage component, and a recharging source.

16. The fishing lure of claim 12, wherein the fishing lure includes a plurality of modular optional components that are able to be selectively added and removed from at least one of the action chamber and the lure body, said plurality of modular optional components including at least one of a chemical concavity, a replaceable skin sheaf, a motion simulation actuator, a hook arrangement, an energy storage component, and a recharging source.

17. The fishing lure of claim 12, further comprising:
a motion simulation actuator configured to mechanically generate movement in a direction along a horizontal plane to simulate movement of live bait fish.

18. The fishing lure of claim 17, wherein splashing effect actuator and the motion simulation actuator when used together cause the fishing lure to move in a horizontal and a vertical plane and to selectively generate said splashing effects depending on a relative vertical position of the fishing lure relative to a surface of the body of water.

19. A method for kite fishing comprising:
attaching an fishing lure to a fishing line, hooking the fishing line to a kite fishing clip attached to a kite fishing assembly;
deploying the fishing lure into a body of water; and
when deployed, the fishing lure utilizing an electrical energy component internal to the fishing lure to generate mechanical energy that powers a splashing effect actuator, wherein said splashing effect actuator automatically generate a splashing effect on a surface of the body of water, said generated splashing effect emulating splashing produced by live bait fish when the live bait fish are attached to a similar kite fishing assembly and are deployed in a body of water.

20. The method of claim 19, wherein the fishing lure is shaped to emulate at least one of a goggle-eye, a blue runner, a pilchard, a herring, a Spanish sardine, a speedo, a cigar minnow, a ballyhoo, a bonito, a grunt, a mullet, a jack, a tuna, a skip jack, and a squid.
